(19) United States
(12) Patent Application Publication
(10) Pub. No.: US 2020/0148857 A1
(43) Pub. Date: May 14, 2020

(54) STABILIZED BIOFILLER PARTICLES AND POLYMER COMPOSITIONS INCLUDING THE SAME

(71) Applicant: XINOVA, LLC, Seattle, WA (US)

(72) Inventors: Angele SJONG, Louisville, CO (US); William Brenden CARLSON, Shoreline, WA (US)

(21) Appl. No.: 16/631,039

(22) PCT Filed: Jul. 17, 2018
(86) PCT No.: PCT/US2018/042473

§ 371 Date: Jan. 14, 2020

Related U.S. Application Data
(60) Provisional application No. 62/534,836, filed on Jul. 20, 2017.

(51) Int. Cl. C08K 9/04; C08J 3/20; C08K 9/10

(52) U.S. Cl. CPC C08K 9/04; C08J 2300/00; C08K 9/10; C08J 3/203

(57) ABSTRACT

Embodiments, described herein relate to methods, compositions, and articles including sacrificial material-coated biofiller particles dispersed in one or more additional polymers.

### CROSS-REFERENCE TO RELATED APPLICATIONS

This application claims priority to U.S. Provisional Application No. 62/534,836 filed on 20 Jul. 2017, the disclosure of which is incorporated herein, in its entirety, by this reference.

### BACKGROUND

Unused fibers from plants are typically burned for energy, composted, used for filler, or discarded. Such fibers may include husks, shells, stems, or other non-fruit or non-seed plant materials. Some plant fibers can be used to produce fuels (e.g., ethanol or syngas).

Fiber from wood and other renewable sources can be used in fiber-reinforced composites (sometimes called natural fiber reinforced composites), such as for extruded building products (e.g., decking), automotive applications, or packaging. Untreated fibers are susceptible to rot and spoilage due to moisture, fungal growth, etc. Such rot or spoilage can lead to premature failure of composites. Rot and failure, including browning and odor formation, can occur during manufacture, use, or storage.

### SUMMARY

Techniques are generally described that include methods, compositions, and articles including sacrificial material-coated biofiller particles dispersed in one or more additional polymers.

An example method of stabilizing a biofiller is disclosed. The method includes combining biofiller particles with a sacrificial material, wherein the sacrificial material includes a saturated hydrocarbon having at least 8 carbons and a single carbonyl functional group, wherein the plurality of biofiller particles include one or more of a protein or an amino acid having amino groups on a surface thereof. The method includes reacting the sacrificial material with the plurality of biofiller particles to form stabilized biofiller particles having a coating of sacrificial material thereon.

An example method of forming a polymer composition including stabilized biofiller particles is disclosed. The method includes stabilizing a plurality of biofiller particles with saturated hydrocarbons having one aldehyde group via an incomplete Maillard reaction to form stabilized biofiller particles having a saturated hydrocarbon coating. The method includes dispersing the stabilized biofiller particles in a polymer to form a polymer composition having the stabilized biofiller particles therein.

An example polymer material is disclosed. The example polymer material includes a polymer matrix and a plurality of saturated hydrocarbon-coated biofiller particles substantially homogenously dispersed in the polymer matrix.

Features from any of the disclosed embodiments may be used in combination with one another, without limitation. In addition, other features and advantages of the present disclosure will become apparent to those of ordinary skill in the art through consideration of the following detailed description and the accompanying drawings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is a schematic illustrating a method of stabilizing biofiller particles and forming a polymer composition including the same;

FIG. 2 is a schematic illustration of biofiller particle;

FIG. 3 is a schematic illustration of a stabilized biofiller particle;

FIG. 4 is a schematic illustration of a pulsed electric field apparatus;

FIG. 5 is schematic illustration of a porous biofiller particle;

FIG. 6 is a schematic illustration of a stabilized porous biofiller particle;

FIG. 7 is a flow chart of a method of forming a polymer composition and articles having stabilized biofiller particles;

FIGS. 8A-8C are schematic illustrations of articles having any of the polymer compositions disclosed herein,

all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are implicitly contemplated herein.

This disclosure is drawn, inter alia, to methods, systems, products, devices, and/or apparatus generally related to compositions having a plurality of biofiller particles having a sacrificial material bound thereto. The sacrificial material may be bound to terminal amine groups of the biofiller particles (e.g., terminal amino groups of an amino acid or protein in the biofiller particles) at a carbonyl functional group of the sacrificial material. The reactions disclosed herein are incomplete or prematurely terminated Maillard reactions. Terminating a Maillard reaction may include using a saturated or fatty aldehyde to prevent isomerization reactions from occurring that lead to further reaction products. Such isomerization reactions occur due to the presence of adjacent hydroxyl groups in the reactants of the Maillard reactions (or sub-reactions thereof). By eliminating surface hydroxyl groups in at least some of the reactants, the Maillard reaction is terminated at an intermediate isomerization stage, prior to producing browning and odors.

The sacrificial material(s) may halt Maillard reactions and reduce or eliminate the prevalence of Maillard reaction products that produce browning and odor formation in biofiller particles. Additionally, bonding sacrificial material having a hydrophobic tail, to the biofiller particles, may allow more uniform dispersion of the biofiller particles in a polymer, such as to prevent unwanted agglomeration of biofiller particles. Bonding the sacrificial material to the biofiller particles may include using a pulsed electric field. The biofiller particles in the resulting composition are stabilized (e.g., sealed from oxygen and liquids) via the polymerizations by the resulting polymeric coating. The biofiller particles are also stabilized (e.g., against browning, odor formation, or other decomposition) by binding the sacrificial material thereto. Further stabilization can be achieved by selected control of the temperature and duration of reaction conditions such as the time that a pulse electric field is applied.

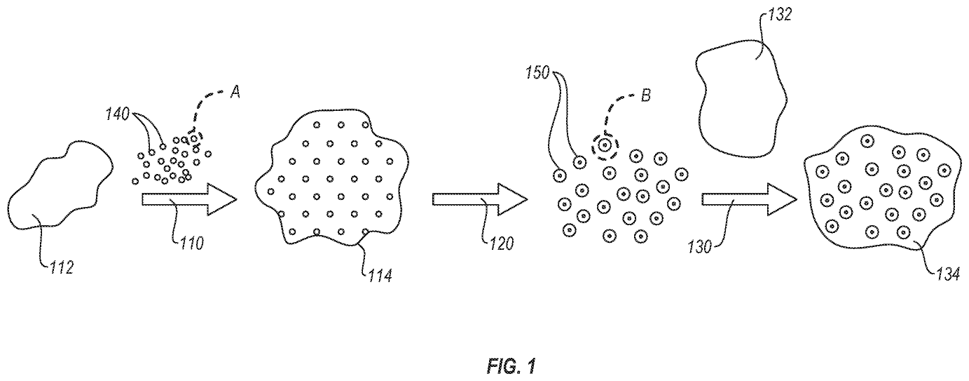

FIG. 1 is a schematic illustrating a method 100 of forming stabilized biofiller particles and a polymer composition including the same, according to at least one example. An example method may include one or more operations, functions or actions as illustrated by one or more of acts 110, 120, and/or 130.

An example method 100 may begin with acts 110, which includes “combining biofiller particles with a sacrificial material.” Acts 110 may be followed by acts 120, which includes “non-thermally reacting the biofiller particles with the sacrificial material to form stabilized biofiller particles.” Acts 120 may be followed by acts 130, which includes “dispersing the stabilized biofiller particles in a polymer to form a polymer composition having the stabilized biofiller particles.”

The acts included in the described example methods are for illustration purposes. In some embodiments, the acts may be performed in a different order. In some other embodiments, various acts may be eliminated. In still other embodiments, various acts may be divided into additional acts, supplemented with other acts, or combined together into fewer acts. Other variations of these specific acts are contemplated, including changes in the order of the acts, changes in the content of the acts being split or combined into other acts, etc. In some examples, act 110 combining biofiller particles with a sacrificial material may be performed substantially simultaneously with act 120 non-thermally reacting the biofiller particles with the sacrificial material to form stabilized biofiller particles. In some examples, act 130 may be removed and the method may be a method of stabilizing biofiller particles where the product of the method includes stabilized biofiller particles.

Act 110 includes “combining biofiller particles with a sacrificial material.” In some examples, combining biofiller particles with a sacrificial material may include dispersing, mixing, or otherwise contacting the biofiller particles with a sacrificial material. Each of the biofiller particles and sacrificial material are described in detail below.

In some examples, combining biofiller particles with a sacrificial material may include using or providing a plurality of biofiller particles 140. In some examples, providing a plurality of biofiller particles 140 can include providing a plurality of biofiller particles 140 of one or more species (e.g., ground nut shells, husks, grasses, wood, pulp, etc.). In some examples, one or more of grass(es), crops (e.g., corn, soybeans, flax, etc.) or crop residues, pulp (e.g., wood pulp, paper pulp) or pulp residues, coconut hulls, walnut shells, rice husks, peanut shells, cellulose, nanocellulose, crystalline nanocellulose, bacterial cellulose, microfibrillated cellulose, microcrystalline cellulose, any other suitable biomass, or combinations of any of the foregoing, may be used as biofiller particles 140. For example, the biofiller particles may include one or more ground plant fibers, such as ground pulp, husks, shells, hulls, fruit, or seeds of one or more plants.

The biofiller particles 140 may be at least partially dehydrated or dried. In some examples, providing a plurality of biofiller particles 140 includes providing a plurality of randomly sized (e.g., unprocessed or unsized) biofiller particles 140. In some examples, providing a plurality of biofiller particles 140 includes providing a plurality of biofiller particles 140 having a selected average particle size. For example, the selected average particle size can include various particle size distributions such as a single average particle size (e.g., single modal distribution), a combination of two different average particle sizes (e.g., bimodal distribution), a trimodal distribution of particle sizes, or any other multimodal distribution. The average particle size of the biofiller particles may be based upon a measurement of a major axis or largest dimension of individual biofiller particles or a diameter of the biofiller particles (e.g., such as when substantially round particles are used).

The average particle size of a single mode of biofiller particles 140 can be in the micron range or more than about 1 μm, such as in a range from about 1 μm to about 2 mm, about 5 μm to about 1 mm, 1 μm to about 500 μm, about 2 μm to about 300 μm, about 5 μm to about 100 μm, about 50 μm to about 200 μm, about 100 μm to about 300 μm, about 250 μm to about 500 μm, about 5 μm to about 50 μm, about 10 μm to about 40 μm, about 1 μm to about 20 μm, about 1 μm to about 10 μm, about 2 μm to about 10 μm, about 5 μm to about 15 μm, about 10 μm to about 20 μm, about 20 μm to about 30 μm, about 30 μm to about 40 μm, about 40 μm to about 50 μm, about 1 μm to about 50 μm, about 5 μm to about 45 μm, than about 500 μm, less than about 300 μm, less than about 100 μm, less than about 50 μm, less than about 40 μm, less than about 30 μm, less than about 20 μm, less than about 10 μm, less than about 5 μm, or about 5 μm. In some examples, the average particle size of at least one mode of particles may be less than 1 μm or more than 500 μm. Any combinations of the above-noted average particle sizes and ranges thereof may be used as separate modes of a bimodal or greater distribution of average particle sizes of the biofiller particles 140. In some examples, the individual particle size of each of the plurality of biofiller particles 140 in a single mode may be substantially the same (e.g., deviating only 10% or less from the average particle size of the single mode).

In some examples, providing a plurality of biofiller particles 140 may include sizing the plurality of biofiller particles 140 to the selected average particle size, such as via one or more of grinding (e.g., wet grinding), chopping, shredding, sieving, pulverizing, or chemically treating (e.g., at least partially dissolving) the plurality of biofiller particles 140. In such examples, providing a plurality of biofiller particles 140 may include providing the plurality of biofiller particles 140 that have been ground or otherwise sized to the selected average particle size(s). The selected average particle size may be selected based upon the use of the polymer composition and desired properties thereof. For example, larger biofiller particles 140 may be selected when a specific strength or density is desired for the polymer composition (e.g., polymer composite).

In some examples, providing a plurality of biofiller particles 140 may include producing the biofiller particles 140, such as by obtaining a biomass and grinding or otherwise sizing the biomass to provide biomass particles, shelling and separating nuts from nut hulls, or forming a biofiller pulp. In some examples, providing a plurality of biofiller particles 140 can include providing a plurality of biofiller particles 140 of one or more of any of the biofiller particle species disclosed above. In some examples, providing the biofiller particles 140 may include pretreating the biofiller particles 140, such as by subjecting the biofiller particles to basic (e.g., sodium hydroxide) or acidic conditions (e.g., sulfuric acid) sufficient to cause the surfaces 144 of the biofiller particles 140 to exhibit surface functional groups (e.g., functional groups, such as amino groups, capable of bonding to the stabilizing material) thereon.

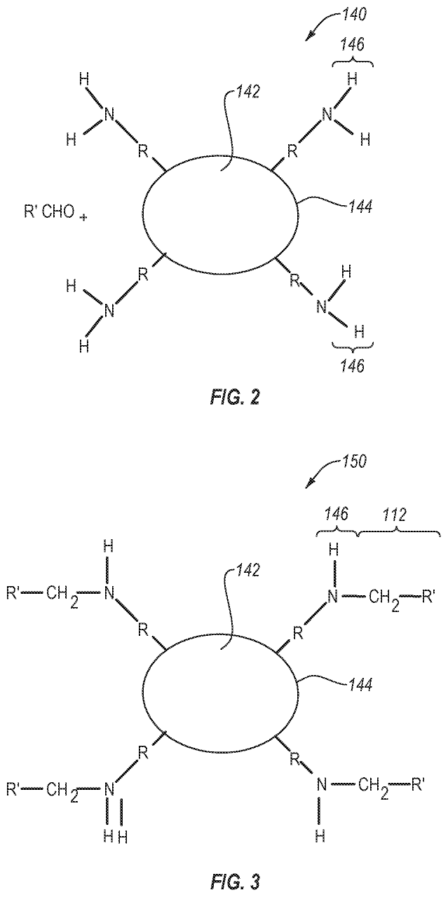

FIG. 2 is a schematic of an example biofiller particle 140 in the region A of FIG. 1. The biofiller particle 140 may include a body 142, a surface 144, and one or more surface functional groups 146 bound to and at least partially defining the surface 144. The surface functional groups 146 may include one or more species of functional groups configured to bond to the sacrificial material. For example, the surface functional groups 146 can include an amine such as a chemical having one or more amino groups. In some embodiments, the surface functional group 146 may include a derivative of an amino group such as a secondary amine, tertiary amine, an organic amino salt, or organic amino ion (e.g., an amino acid having a positive charge on the nitrogen atom of a terminal amino group thereon). For example, and as shown in FIG. 2, the surface functional groups 146 may be a portion of an amino acid or protein, R, having one or more amino groups. In such examples, the surface 144 may include a plurality of surface functional groups 146 that are exposed terminal amino groups of amino acids or proteins R. In some examples, the biofiller particle 140 may comprise cellular material having a plurality of proteins or amino acids R. The surface of the biofiller particles 140 may include a plurality of terminal amino groups from said proteins or amino acids R, which terminal amino groups make up the surface functional groups 146.

Returning to FIG. 1, in some examples, act 110 combining biofiller particles with a sacrificial material may include using or providing the sacrificial material 112. The sacrificial material can be used to terminate Maillard reactions at the biofiller particle surface, resulting in incomplete Maillard reactions wherein the product thereof is not capable of continuing along the Maillard reaction pathway(s). Maillard reactions typically occur when (aldehyde functional groups of) reducing sugars react with amine groups of amino acids. Such reactions may be desirable in some instances, but result in browning and odor formation in biofiller particles upon further reaction between hydroxyl containing reducing sugars. By using sacrificial material that has a carbonyl (e.g., aldehyde) functional group head and a (saturated) hydrophobic tail, Maillard reactions involving isomerizations can be terminated or avoided. For example, by using a saturated or fatty aldehyde, isomerization reactions that lead to other reaction products can be terminated or avoided. Terminating a Maillard reaction may include bringing the Maillard reaction product the point at which the products of a Maillard reaction are thermodynamically and kinetically stable and as such the Maillard series of reactions no longer proceed forward.

Maillard reactions are very complex. The initial step of a Maillard reaction involves the reaction between an aldehyde and an amine. The aldehyde is typically located on the carbohydrate polymer while the amine group is typically located on the proteins. The reaction gives the characteristic R—NH—C(═O)—R′ where R is the carbohydrate and R′ is the protein of the initial stages of the reaction. Typically, this characteristic R—NH—C(═O)—R′ is an Amadori compound. From this initial product, many different paths exist to create the odors, flavors, and browning of the Willard reaction. Many of these paths lead to furan, pyrrole, and pyridine derivatives. For example, when the aldehyde includes a carbohydrate R having one or more hydroxyl groups, various isomerizations of the Amadori compounds may form isomerization products such as 3-deoxyosone, 1,2-enol, 2-glucosulose, imidazolone, 2,3-enediol, fructosamine, 3-deoxyglucosone, pyrraline, pentosidine, 1-deoxy-fructose-3-ulose, erythronic acid, etc. However, by using a saturated aldehyde the initial Maillard reaction product may be the terminal reaction product due at least in part to the absence of hydroxyl groups thereon.

Further, the (saturated) hydrophobic tail may allow for homogenous dispersion in a polymer. Such sacrificial materials 112 disclosed herein are relatively smaller and more mobile than polysaccharides, proteins, or complex carbohydrates present in biofiller particles 140 and therefore are able to outcompete said materials for binding to the surface functional groups of the biofiller particles, thereby rendering the biofiller particles substantially hydrophobic and terminating/preventing Maillard reactions.

The sacrificial material 112 can include a chemical species configured to covalently bond to the surface functional groups 146 (FIG. 2) of the biofiller particles 140 and render the surface of the biofiller particles 140 substantially hydrophobic. In some examples, the sacrificial material 112 may include a reducing group which may bond to available amino groups. In some examples, the sacrificial material 112 may include a hydrocarbon having a single carbonyl functional group capable of reacting with an amine or amino functional group. Such carbonyl functional groups can include an aldehyde. For example, the sacrificial material 112 may include one or more saturated hydrocarbons (e.g., alkyl structural groups) each having a single aldehyde group thereon.

In some examples, the single carbonyl functional group can include a carboxylic acid, or an acid halide (e.g., a fatty acid bromide) functional group. The single carbonyl functional group of the sacrificial material is composed to react with the amines on a protein or amino acid to form a stable bond (e.g., a bond not readily changed or converted in further Maillard reaction pathways) between the sacrificial material 112 and the surface functional groups 146. In some embodiments, the sacrificial material 112 may include a keto group instead of a single carbonyl functional group. In such examples, the keto group may bond to amines of the biofiller particles.

The sacrificial material 112 may include at least 8 carbon atoms therein, such as in a range from about 8 to about 40 carbon atoms (e.g., CH₂ units), about 10 to about 30 carbon atoms, about 8 to about 20 carbon atoms, about 20 to about 40 carbon atoms, less than about 40 carbon atoms, or less than about 20 carbon atoms therein. In some examples, the sacrificial material 112 may include one or more aldehydes, such as one or more saturated (e.g., alkyl), branched or unbranched aldehydes. The sacrificial material 112 may include at least one hydrophobic moiety or functional group. The one or more aldehydes may be amphiphilic, having a hydrophilic head (e.g., the aldehyde functional group, —CHO) and a hydrophobic tail (the aliphatic alkyl tail). For example, the sacrificial material 112 can include an amphiphilic material (e.g., chemical, polymer, etc.) comprising a hydrophilic head (e.g., aldehyde group) that can bond to the outer surface 142 of the biofiller particles 140 (e.g., at a surface functional group 144), and, the hydrophobic tail (e.g., saturated alkyl tail) that can extend outwardly from the biofiller particle surface 142. The number of carbons in the branched or unbranched, saturated (e.g., alkyl) tail of the one or more aldehydes in the sacrificial material 112 may be selected to provide a specific hydrophobicity to the resulting coated biofiller particle(s).

The one or more aldehydes may be free of any additional functional groups—aside from the aldehyde functional group—that would react with the surface functional group 146. For example, the sacrificial material 112 may include a saturated aldehyde that is substantially free of one or more of hydroxyl, carbonyl (e.g., aside from the single aldehyde functional group of the saturated aldehyde), ether, keto, or halo functional groups. For example, the one or more aldehydes may include one or more C₈-C₄₀ straight-chain saturated monoaldehydes (e.g., aldehyde having a saturated alkyl tail). In some examples, the one or more aldehydes may include a saturated, straight-chain aldehyde having at least 8 carbon atoms therein. In some examples, the one or more aldehydes may include one or more methyl groups, ethyl, groups, propyl groups, etc., on a saturated aldehyde backbone (e.g., alkyl tail of an aldehyde). In some examples, the sacrificial material 112 may include octanal, nonanal, decanal (capric aldehyde), undecanal, dodecanal (lauryl aldehyde), tridecanal, butadecanal (myristyl aldehyde), hexadecanal (palmytyl aldehyde), heptadecanal, octadecanal (stearyl aldehyde), 2,4,4-trimethylpentanal, 3,5,5-trimethylhexanal, 2-methyloctanal, 3-methyloctanal, 4-methyl-ocatanal, 3-ethylocatanal, 2,2-dimethylnonanal, 2-methylundecanal, 10-methyldodecanal, 2-propyldecanal, 14-methylpentadecanal, (9R)-3,5,9-trimethyldodecanal (e.g., stylopsal), or any other branched or unbranched, saturated monoaldehyde (the above are merely some examples), a derivative of any of the foregoing, or combinations of any of the foregoing. In some examples, the sacrificial material 112 may have a general formula of CH₃(CH₂)ₙCHO, where n=6-38. In some examples, the derivative of an aldehyde may include a reaction product of an aldehyde, a salt of any an aldehyde, or an ion of any of an aldehyde (such as any of the aldehydes disclosed herein).

While some examples include sacrificial material 112 having no hydroxyl groups therein in some examples, the sacrificial material 112 may additionally or alternatively include a limited number of hydroxyl groups. In such embodiments, the number of hydroxyl groups may be limited to a number sufficient to ensure that the sacrificial material retains a selected hydrophobicity (e.g., a ratio of the hydroxyl groups to the number of saturated carbon units in the sacrificial material remains in favor of more saturated carbon units than hydroxyl groups, such as at least 1:3) and that any hydroxyl groups present cannot participate in isomerization reactions. In some examples where the sacrificial material 112 includes some hydroxyl groups, the sacrificial material 112 may include 1, 2, 3, or 4 hydroxyl groups on an alkyl backbone. In some examples where the sacrificial material 112 includes some hydroxyl groups, the sacrificial material 112 may include at least one methylene group between the carbonyl carbon of the sacrificial material and a carbon bearing a hydroxyl group. For example, a larger the number of methylene units between a hydroxyl group and the carbonyl carbon head of the sacrificial material correspondingly lowers the risk of unwanted side reactions between the hydroxyl groups and the biofiller particles (e.g., unwanted browning and odor forming reactions).

In some examples, combining biofiller particles with a sacrificial material may include applying the sacrificial material 112 to biofiller particles 140, such as any of the sacrificial materials 112 disclosed herein. For example, combining biofiller particles with a sacrificial material may include applying a saturated aldehyde that is substantially free of hydroxyl groups to the biofiller particles. In some examples, combining biofiller particles with a sacrificial material may include applying one or more of branched or unbranched, saturated aldehydes to the biofiller particles. In some examples, combining biofiller particles with a sacrificial material may include applying one or more straight-chain saturated aldehydes to the biofiller particles, such as a C₈-C₄₀ straight chain aldehyde. In some examples, combining biofiller particles with a sacrificial material may include applying one or more branched, saturated aldehydes to the biofiller particles, such as a C₈-C₄₀ aldehyde having a straight-chain alkyl backbone including one or more methyl or ethyl substituent groups extending therefrom.

In some examples, combining the biofiller particles with the sacrificial material may include disposing the biofiller particles in the sacrificial material. For example, disposing the biofiller particles in the sacrificial material may include pouring, mixing, dispersing, suspending, immersing, or otherwise contacting the biofiller particles with the sacrificial material. For example, combining the biofiller particles with the sacrificial material may include placing biofiller particles 140 in a conduit or vessel containing the sacrificial material 112.

In some examples, the sacrificial material 112 may be provided as a solid or a liquid, such as in solution (e.g., in a solvent). For example, the sacrificial material 112 may be provided as a substantially pure liquid, including substantially only one or more sacrificial material species therein. In some examples, providing the sacrificial material may include dissolving, suspending, mixing or otherwise combining the sacrificial material in a solvent. For example, the sacrificial material may be added to a solvent prior to, contemporaneous with, or after combining the sacrificial material 112 with the biofiller particles 140. For example, combing the biofiller particle with a sacrificial material may include dispersing the sacrificial material (e.g., saturated hydrocarbons containing one aldehyde group) and the plurality of biofiller particles in a solvent. In some examples, the solvent can be composed to be non-reactive with the biofiller particles (e.g., with the surface functional groups). In some examples, the solvent may include water, dichloromethane, carbon tetrafluoride, toluene, diethyl ether, tetrahydrofuran, any other solvent that is non-reactive to one or more of the surface functional groups and the sacrificial material, or mixtures of any of the foregoing. In some embodiments, the volume percentage (vol %) of the sacrificial material in a mixture of the sacrificial material and the solvent may be about 1 vol % or more, such as in a range from about 1 vol % to about 99 vol %, about 10 vol % to about 90 vol %, about 1 vol % to about 25 vol %, about 25 vol % to about 50 vol %, about 50 vol % to about 75 vol %, about 75 vol % to about 99 vol %, less than about 90 vol %, less than about 50 vol %, or less than about 30 vol % of the mixture of the sacrificial material and the solvent.

In some examples, the sacrificial material 112 may be provided as a solid (e.g., below a melt temperature for the sacrificial material) such as grains or particles. Subsequently, the sacrificial material may be heated to a temperature above a melting temperature of the sacrificial material. In some examples, the sacrificial material 112 may be at least partially dissolved in a solvent.

In some examples, combining the biofiller particles with the sacrificial material may include disposing the biofiller particles in the solvent. For example, the biofiller particles may be disposed in a solvent prior to combining with the sacrificial material. In such examples, combining biofiller particles with a sacrificial material may include diffusing the sacrificial material into the biofiller particles that are dispersed in the solvent. In some examples, combining the biofiller particles with the sacrificial material may include diffusing the sacrificial material into and/or through the biofiller particles, without using a solvent, such as using only the sacrificial material in fluid form. In some examples, the method 100 may include applying ultrasonic stimulation to the sacrificial materials and the biofiller particles, such as when dispersed in the solvent. Such ultrasonic stimulation may provide improved penetration and surface coverage of the sacrificial material into and onto the biofiller particles.

In some examples, the combined biofiller particles 140 and sacrificial material 112 form a mixture 114. The sacrificial material content of the mixture may be about 1 weight percent (wt %) or more of the mixture 114, such as in a range from about 1 wt % to about 99 wt %, about 10 wt % to about 90 wt %, about 1 wt % to about 25 wt %, about 25 wt % to about 50 wt %, about 50 wt % to about 75 wt %, about 75 wt % to about 99 wt %, less than about 90 wt %, less than about 50 wt %, or less than about 30 wt % of the mixture 114. The balance of the mixture 114 may include one or more of the biofiller particles 140, one or more solvents, catalysts, or other components.

Act 120 includes “non-thermally reacting the biofiller particles with the sacrificial material to form stabilized biofiller particles.” In some examples, non-thermally reacting the biofiller particles with the sacrificial material to form stabilized biofiller particles may include inducing reaction conditions that are effective to cause the sacrificial material 112 to bond to the biofiller particles 140 and form coated or stabilized biofiller particles having a coating of sacrificial material thereon. In some examples, the term “non-thermal” with respect to reactions or reacting includes performing said reactions at a temperature below reaction temperatures of Mailiard reactions, such as below about 140° C. or any other of the reaction temperatures disclosed herein. In such examples, the reactions do not progress through the typical thermal reaction schemes, but rather progress via catalyzed or PEF induced reactions well below typical Maillard reaction temperatures (e.g., above 140° C.). In some examples, the coating may include reacted sacrificial material, such as a derivative form of the sacrificial material 112 that is covalently bonded to a surface functional group 146 (FIG. 1) of the biofiller particles 140. Such derivatives may include the reaction product of an aldehyde, such as an aldehyde wherein the carbonyl carbon therein is covalently bonded to the nitrogen atom of the amino group of an amino acid or protein at the surface of the biofiller particle. In some examples, non-thermally reacting the biofiller particles with the sacrificial material to form stabilized biofiller particles may include utilizing reaction conditions suitable for limiting or eliminating Maillard reaction products, such as Amadori compounds. Such reaction conditions may include limiting temperature of the mixture and/or reactions, limiting or eliminating one or more sugars in the mixture, and/or limiting or eliminating the amount of compounds having hydroxyl moieties in the mixture 114. Reaction conditions may vary based upon the sacrificial material and/or biofiller particles used. By selectively controlling the reaction conditions, the normally favored Maillard reactions can be limited or eliminated, thereby reducing or eliminating browning and odor formation in the biofiller particles 140.

In some examples, reacting the sacrificial material with the biofiller particles includes non-thermally reacting the sacrificial material with the biofiller particles, such as by applying a pulsed electric field (“PEF”) to the biofiller particles 140 and sacrificial material 112 (e.g., to the mixture 114). In some examples, applying a PEF to the sacrificial material and the biofiller particles may be effective to cause sacrificial material 112 to bond to the biofiller particles 140. For example, the PEF may be effective to cause the carbonyl functional group of the sacrificial material 112 (e.g., carbonyl carbon of the saturated hydrocarbon aldehyde) to conjugate to the amino groups of the biofiller particles (e.g., terminal amino nitrogen of the amino acids or proteins). In some examples, non-thermally reacting the sacrificial material with the biofiller particles by applying PEF may include cycling the biofiller particles 140, sacrificial material 112, or both (mixture 114) through a conduit or vessel in a PEF generator. Such cycling can include a continuous flow or batch-wise processing in the PEF generator.

In some examples, reacting the sacrificial material with the biofiller particles may include reacting the sacrificial material with the biofiller particles for a duration effective to cause at least some of the biofiller particles to be at least partially (e.g., substantially completely) encapsulated in a layer of the sacrificial material 112. A partial coating or total encapsulation may stabilize the biofiller particles by limiting or preventing browning and odor formation, as well as making the biofiller particles more dispersible in a hydrophobic polymer (e.g., allow for homogenous distribution of stabilized biofiller particles in a polymer). For example, hydrophobic tails of the sacrificial material 112 may extend from the surface of the biofiller particles and prevent penetration by water and rot therefrom because the surface of the stabilized biofiller particles is hydrophobic. Additionally, the hydrophobic tails and lack of hydroxyl groups thereon may prevent/terminate Maillard reactions from progressing, resulting in incomplete Maillard reactions. In some examples, applying the PEF to the biofiller particles 140 and sacrificial material 112 may be carried out for about 5 millisecond (ms) or less, such as in a range from about 1 ms to about 5 ms, about 1 ms to about 3 ms, about 2 ms to about 4 ms, about 3 ms to about 5 ms, less than about 3 ms, or less than about 2 ms. Such durations may be effective to allow or cause the outer surface of the biofiller particles to be at least partially coated with the sacrificial material and/or become substantially hydrophobic.

In some embodiments, combining the biofiller particles with the sacrificial material or applying the sacrificial material to the biofiller particles may include diffusing the sacrificial material into one or more pores on the surfaces of the biofiller particles. As discussed in more detail below, combining the biofiller particles with the sacrificial material and/or non-thermally reacting the sacrificial material with the biofiller particles may include forming pores in the biofiller particles. In some examples, applying the PEF may be carried out only on the biofiller particles 140 or an additional PEF treatment may be applied to the biofiller particles 112 prior to combining the same with the sacrificial material 112.

In some examples, applying the PEF to the biofiller particles 140 and sacrificial material 112 may include applying a selected PEF intensity. For example, applying the PEF to the biofiller particles 140 and sacrificial material 112 may include applying at least about 1 kV/cm to the biofiller particles 140 and sacrificial material (e.g., mixture 114), such as in a range from about 1 kV/cm to about 100 kV/cm, about 5 kV/cm to about 80 kV/cm, about 10 kV/cm to about 60 kV/cm, about 20 kV/cm to about 50 kV/cm, about 1 kV/cm to about 20 kV/cm, about 20 kV/cm to about 40 kV/cm, about 40 kV/cm to about 60 kV/cm, less than about 60 kV/cm, or less than about 40 kV/cm. Any of the above intensities may be applied for any of the durations disclosed herein. For example, applying the PEF to the sacrificial material and the biofiller particles may include applying the PEF with an intensity in a range from about 10 kV/cm to about 60 kV/cm and for a duration of less than about 5 ms.

In some examples, non-thermally reacting sacrificial material with the biofiller particles may include using a catalyst, such as an acid catalyst. An acid catalyst may include ammonium ions or weaker acids than ammonium ions. Acid catalysts may be used, but require careful control of the amount and strength of the acid such that the desired reactions are not terminated by formation of excess ammonium ions due to the extent of the reactions between the amines and the acid catalyst. In some examples, the amount of acid may be less than the amount of free amino groups in the biofiller particles, such as less than about half of the amount of free amino groups in the biofiller particles.

In some examples, non-thermally reacting the biofiller particles can include maintaining a temperature, in the mixture 114, below 140° C., such as in a range from about 0° C. to 140° C., about 20° C. to about 120° C., about 25° C. to about 100° C., about 0° C. to about 70° C., or less than about 100° C. The above-noted temperatures may be the bulk temperature of the mixture 114, ignoring microscale heating in discrete portions of the mixture 114, such as when induced by a pulsed electric field. The above-noted temperatures are below typical Maillard reaction temperatures, which occur above 140° C.

As a result of act 120 non-thermally reacting the biofiller particles with the sacrificial material to form stabilized biofiller particles, the stabilized biofiller particles 150 are formed. The stabilized biofiller particles 150 include biofiller particles 140 having the sacrificial material 112 bonded thereto. FIG. 3 is a schematic illustration of a stabilized biofiller particle 150, according to at least one example. The stabilized biofiller particle 150 includes the biofiller particle 140 having the body 142, surface 144, and surface functional groups 146. The surface functional groups 146 may be bonded (e.g., conjugated) to the sacrificial material 112. As noted above, the sacrificial material may include the bonded derivative of the sacrificial material 112. For example, the sacrificial material 112 may include a derivative of an aldehyde, such as a reaction product of an aldehyde that has lost an oxygen atom and a hydrogen atom through a bonding reaction with the amino group of the surface functional group 146. The sacrificial material 112 may include a tail indicated by the notation R′ (e.g., hydrophobic tail). As noted above, the tail R′ may be hydrophobic, such as brandied or straight-chain, saturated alkyl group(s). The sacrificial material 112 may include any of number of the carbon units disclosed above, such as in a range from about 8 carbon units to about 40 carbon units.

The sacrificial material 112 may at least partially envelop the surface 144 of the biofiller particles. For example, the sacrificial material 112 may bond to amino groups at the surface of the biofiller particle to an extent that is effective to form a hydrophobic coating that at least partially or completely encapsulates the surface 144. In such examples, the surface 144 may be at least partially impermeable to water, and, Maillard reactions at the surface 144 may be limited or avoided.

Returning to forming pores in the biofiller particles, act 110 combining the biofiller particles with the sacrificial material and/or act 120 non-thermally reacting the sacrificial material with the biofiller particles may include forming pores in, or roughening the surface of, the biofiller particles 140. As noted above, applying the PEF to the biofiller particles may result in electroporation or pore formation in the biofiller particles, such as at least one surface of the biofiller particles. Accordingly, combining the biofiller particles with the sacrificial material, non-thermally reacting the sacrificial material with the biofiller particles, or both may include forming pores in the biofiller particles by applying PEF to the biofiller particles 140, and optionally, to the sacrificial material 112. In some examples, applying the PEF may be carried out only on the biofiller particles 140 or an initial or additional PEF treatment may such as prior to combining the same with the sacrificial material 112.

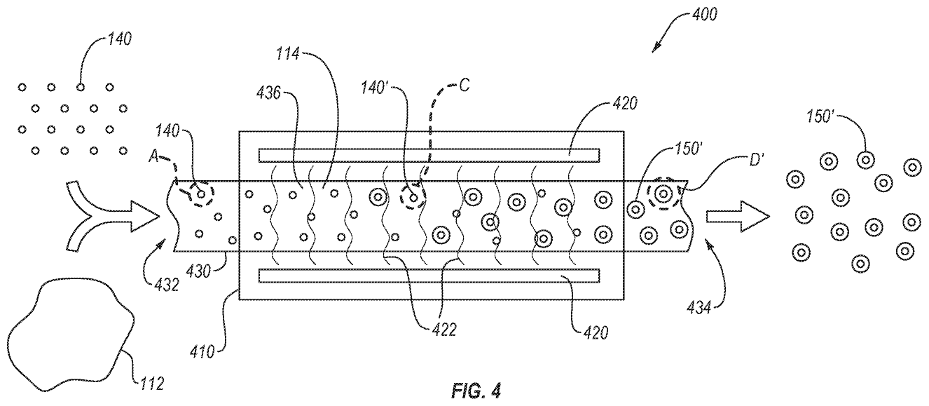

FIG. 4 is a schematic of an apparatus 400 for non-thermally reacting the sacrificial material with the biofiller particles by applying a PEF, according to at least one example. The apparatus 400 may be configured as a PEF generator having a conduit therethrough. The conduit may carry the biofiller particles 140 and sacrificial material 112 (e.g., mixture 114) through a treatment region 404 within the apparatus 400 where the PEF is applied to the biofiller particles 140 and sacrificial material 112. The apparatus 400 may include a housing 410 including one or more PEF emitters 420 (e.g., high voltage pulse generators) therein or thereon. The apparatus 400 may include one or more conduits 430 passing through the housing 410. The one or more conduits 430 may pass from a first end region 402 to a second end region 406 of the housing 410. At the first end region 402, the conduit 430 may include an inlet portion 432 in which material therein enters into the housing 410 and/or between the PEF emitters 420.

The PEF emitters 420 may be tuned to apply a selected intensity of PEF 422 to the material in the conduit 430 in the treatment region 404, such as any of the intensities disclosed herein. The treatment region 434 may be any length suitable to non-thermally react the sacrificial material with the biofiller particles, such as at least about 1 cm, in a range from about 1 cm to about 3 meters, about 5 cm to about 2 meters, about 10 cm to about 1 meter, about 1 meter to about 2 meters, or less than about 3 meters. The PEF emitters 420 may include one or more electrodes (e.g., coils, needles, plates, etc.). As a material to be treated passes between the PEF emitters 420 (e.g., in conduit 430), the PEF 422 is induced/applied therebetween via application of high voltage for a short time (e.g., any of the durations for PEF disclosed above).

The conduit 430 may pass through the housing 410 and/or between the PEF emitters 420 and exit out of the second end region 406 via an outlet portion 434 of the conduit 430. While depicted as substantially linear, the conduit 430 in the treatment region 404 may include one or more bends, curves, or loops, to effectively lengthen the amount of time the material therein spends in the treatment region 404. In some examples, the material forming the conduit 430 may be any material that does not interfere with the PEF 422 or degrade from exposure to PEF 422. In some examples, the PEF emitters 420 may be disposed in the conduit 430. The product may flow out of the outlet 434 portion. The product may include stabilized porous biofiller particles 150′. The stabilized porous biofiller particles 150′ may be similar or identical to the stabilized biofiller particles 150 in one or more aspects.

In some examples, the apparatus 400 may be configured with a vessel in the treatment region 434 therein, for batch-wise treatment of biofiller particles and/or sacrificial material with the PEF 422.

During use, one or more materials may be disposed within the conduit 430 at the inlet portion 432. For example, the inlet portion may include one or more feeder pipes or inlets operably coupled thereto and configured to supply portions of the mixture 114. The inlet portion 432 may be operably coupled to a biofiller particle supply and a sacrificial material supply. The biofiller particles and the sacrificial material can be combined by providing the same into the conduit 430. In some examples, the biofiller particle supply and the sacrificial material supply may be separate or may be the same supply (e.g., single vessel or pipe). In some examples, the biofiller particles 140 may enter the apparatus 400 substantially as described with respect to region A and FIG. 2. As the biofiller particles 140 pass through the treatment region 434 where the PEF 422 is applied thereto, the biofiller particles 140 may undergo electroporation (or electrophoresis), wherein pores are formed therein via electrical stimulation. Formation of pores via electroporation results biofiller particles 140′ having a larger pore population in the biofiller particles 140.

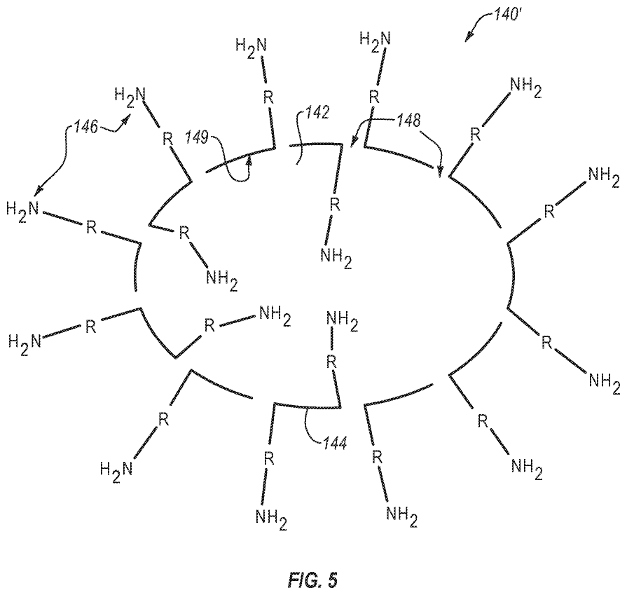

For example, at some intermediate point between the inlet region 432 and the outlet portion 434, the porous biofiller particles 140′ may exhibit a higher number of pores than the biofiller particles 140 entering the apparatus 400. FIG. 5 is a schematic illustration of region C in FIG. 4. FIG. 4, depicts the porous biofiller particle 140′ after being subjected to PEF 422. As shown, the porous biofiller particle 140′ includes a body 142 and outer surface 144, a plurality of surface functional groups 146, and a plurality of pores 148. The plurality pores 148 may provide more surface area, which may allow for more surface functional groups 146 (e.g., bonding sights) than an untreated biofiller particle 140. Additionally, PEF 422 may roughen the surface 144 or expose more surface functional groups 146 on the surface 144 of the biofiller particles. In some examples, surface functional groups 146 below the surface 144, such as inside the pores 148, may be exposed by electroporation induced by the PEF 422. In some examples, sacrificial material can be diffused through the pores 148 to bond to the surface functional groups 146 therein. PEF treatment may result in more surface functional groups for bonding to sacrificial material, than in untreated biofiller particles. The increased number of surface functional groups may allow for greater amounts of sacrificial material to bind to the biofiller particles which may provide higher and/or more uniform particle hydrophobicity and may also provide greater prevention of Maillard reactions than in untreated biofiller particles.

Returning to FIG. 4, as the surfaces of the porous biofiller particles 140′ become more porous and more surface functional groups 146 are exposed, the sacrificial material present in the mixture 114 may bond to the surface functional groups in Maillard terminating reactions. Bonding of the sacrificial material to the surface functional groups result in Maillard terminations due to the lack of hydroxyl groups on the sacrificial material. Accordingly, a sacrificial material coating may form over at least a portion of the surfaces of the porous biofiller particles 140′.

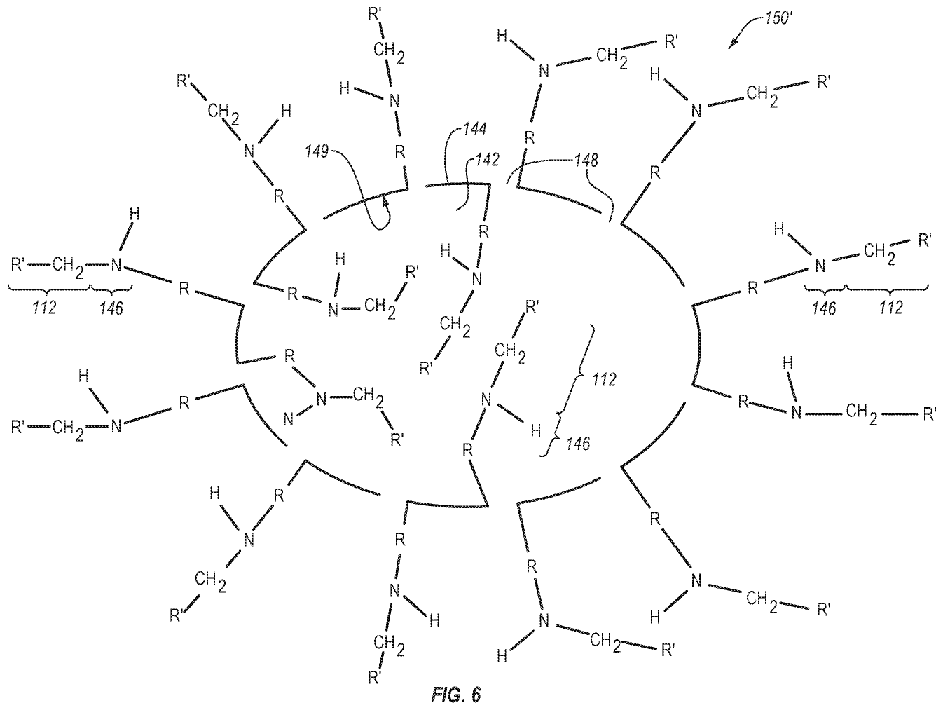

FIG. 6 is as schematic illustration of a stabilized porous biofiller particle 150′ in region D of FIG. 4. The stabilized porous biofiller particles 150 may be formed in the conduit 430 via the application of PEF 422 and/or due to catalysis (e.g., a small amount of acid catalyst). The stabilized porous biofiller particle 150′ may include a larger amount of sacrificial material 112 bound thereto than the stabilized biofiller particles 150 (FIG. 3), due at least in part to the increase porosity induced via electroporation. As shown, the larger number of surface functional groups 146 exposed on the surface 144 and inside of the pores 148, results in a larger number of sacrificial material 112 molecules being bound to the stabilized (porous) biofiller particle 150′ than on the stabilized biofiller particles 150. The characteristics of the stabilized porous biofiller particles 150′ may differ from the characteristics of the stabilized biofiller particle 150. For example, the stabilized porous biofiller particles 150′ may be more hydrophobic, or more uniformly hydrophobic than stabilized biofiller particles 150. The stabilized porous biofiller particles 150′ may be more completely coated or incorporated in the sacrificial material than stabilized biofiller particles 150. Accordingly, the stabilized porous biofiller particles 150′ may be more resistant to rot, browning, odor formation, or other modes of deterioration than stabilized biofiller particles 150. Additionally, the stabilized porous biofiller particles 150′ may be more resistant agglomeration in hydrophobic polymers and more likely to homogenously disperse therein than stabilized biofiller particles 150. In some examples, the term “stabilized biofiller particles” may refer to one or both of the stabilized biofiller particles 150 or the stabilized porous biofiller particles 150′.

Returning to FIG. 4, the stabilized porous biofiller particles 150′ may exit the treatment region 436 via the outlet 434. In some examples, the stabilized porous biofiller particles 150′ may be separated from the mixture 114 (e.g., separated from excess sacrificial material that is not bound to the biofiller particles, and/or from solvents carrying the same). Such separation may be achieved by filtration, sieving, centrifuge, etc.

Returning again to FIG. 1, the method 100 may terminate after act 120, resulting in a plurality of stabilized biofiller particles 150 or 150′ as shown in FIGS. 1 and 4. In some examples, acts 110 and 120 may be performed substantially simultaneously or in series wherein the combined acts 110 and 120 include stabilizing a plurality of biofiller particles with saturated hydrocarbons having one carbonyl group, such as via an incomplete Maillard reaction, to form stabilized biofiller particles having a hydrophobic (e.g., saturated hydrocarbon) coating. The stabilized biofiller particles 150 may be used for further actions or in materials.

In some examples, the method 100 may progress to forming a polymer composition having the stabilized biofiller particles therein. For example, act 120 may be followed by act 130, which includes “dispersing the stabilized biofiller particles in a polymer to form a polymer composition having the stabilized biofiller particles.” In some examples, dispersing the stabilized biofiller particles in (e.g. into) the polymer may include dispersing any of the stabilized biofiller particles disclosed herein into the polymer. For example, dispersing the stabilized biofiller particles into the polymer may include dispersing stabilized biofiller particles that are substantially completely encapsulated by the sacrificial material (e.g., saturated hydrocarbons having one carbonyl group or a derivative thereof such as aldehydes having saturated alkyl tails) into the polymer. In some examples, dispersing the stabilized biofiller particles 150 in a polymer 132 to form a polymer composite 134 having the stabilized biofiller particles 150 therein may include mixing, pouring, agitating, or otherwise combining the stabilized biofiller particles in the polymer.

In some examples, dispersing the stabilized biofiller particles in a polymer to form a polymer composition having the stabilized biofiller particles may include providing the polymer 132. In some examples, dispersing the stabilized biofiller particles into the polymer may include dispersing the stabilized biofiller particles 150 into a polymer matrix including one or more hydrophobic polymers. The polymer 132 may form a polymer matrix of the polymer composition 134. In some examples, the polymer 132 may include one or more hydrophobic and/or thermoplastic polymers such as an acrylic, polyethylene terephthalate, polystyrene, polymethyl methacrylate, polycarbonate, polyethylene (e.g., high-density polyethylene (“HDPE”), low-density polyethylene (“LDPE”)), polyvinyl chloride (“PVC”), polyvinylidenechloride, polyvinylidene fluoride, polytetrafluoroethylene, polylactic acid (“PLA”), a polyhydroxy acid(s) (“PHA”), polyhydroxybutyrate (“PHB”), adipic acid, polyacrylic acid, ethylene vinyl alcohol, acrylonitrile butadiene styrene, polypropylene, polyamide, polyimide, polyurethane, polyetherimide, polyether ether ketone, polysulfone, polyoxymethylene, any other hydrophobic polymer suitable for use in packaging materials (e.g., food packaging, medical device packaging, etc.), derivatives of any of the foregoing (e.g., ions, salts, reaction products, etc.), or copolymers including one or more of any of the foregoing. Further polymers, beyond those listed above, may be used for the polymer 132. In some examples, the polymer 132 may be a homopolymer, copolymer, terpolymer, etc., having any of the polymers disclosed herein. In some examples, the thermoplastic polymer can be sourced from a renewable source, such as polyethylene, polylactic acid, polyhydroxyalkanoates, or polyhydroxybutyrate produced from biomass. In some examples, the polymer can be sourced from non-renewable sources, such as petroleum.

In some examples, dispersing the stabilized biofiller particles in the polymer comprises dispersing the stabilized biofiller particles into the polymer to form a substantially homogenous dispersion, such as polymer composition 134 having a plurality of stabilized biofiller particles therein that are substantially free of agglomerations of the stabilized biofiller particles. In some examples, the polymer composition 134 includes a polymer matrix having a substantially homogenous distribution of stabilized biofiller particles therein.

In some examples, dispersing the stabilized biofiller particles 150 in a polymer 132 to form a polymer composition having the stabilized biofiller particles 150 may include providing the stabilized biofiller particles 150 and the polymer 132 into a mixing apparatus (not shown). The mixing apparatus may include a mixing basin, an extrusion mixer, a stirrer, an ultrasonic agitation device (e.g., sonicator), a turbulent flow apparatus (e.g., conduit having turbulent flow inducing structures), or any other apparatus suitable for mixing the stabilized biofiller particles 150 with the polymer 132.

In some examples, dispersing the stabilized biofiller particles in the polymer may include dispersing an amount of stabilized biofiller particles into the polymer composition effective to form a polymer composition or composite having a selected stabilized biofiller particle and/or polymer content. For example, dispersing the stabilized biofiller particles in the polymer may include using an amount of stabilized biofiller particles effective to cause the polymer composition 134 to have a stabilized biofiller particles 150 of at least about 1 weight percent (wt %) of the polymer composition 134, such as in a range from about 5 wt % to about 50 wt %, about 10 wt % to about 40 wt %, about 15 wt % to about 35 wt %, about 20 wt % to about 30 wt %, about 10 wt % to about 20 wt %, about 20 wt % to about 40 wt %, about 30 wt % to about 50 wt %, less than about 40 wt %, less than about 20 wt %, less than about 10 wt %, or less than about 5 wt % of the polymer composition 134. In some examples, the amount of stabilized biofiller particles 150 in the polymer composition 134 may be selected to provide a specific strength, resiliency, bulk density, polymer material displacement (e.g., replacing a volume of polymer that would be otherwise used the composition), appearance, or combination of any of the foregoing.

The polymer composition 134 or polymeric material may include a polymer matrix and a plurality of stabilized biofiller particles (e.g., saturated hydrocarbon-coated biofiller particles having no hydroxyl groups) substantially homogenously dispersed in the polymer matrix. For example, the polymer composition 134 may include any of the biofiller particles disclosed herein, any of the sacrificial materials disclosed herein, any of the polymers disclosed herein, in any of the configurations or combinations disclosed herein (e.g., porous particles, partially or fully encapsulated, etc.). In some examples, the polymer composition 134 may include the plurality of stabilized (e.g., saturated hydrocarbon-coated) biofiller particles including a plurality of saturated hydrocarbon molecules conjugated to biofiller particles at amino groups or derivatives thereof on a surface of a respective one of the biofiller particles. In some examples, the sacrificial material (e.g., plurality of saturated hydrocarbon molecules) bound to the biofiller particles may be substantially free of hydroxyl groups. In some examples, each of a plurality sacrificial material molecules may be conjugated to a biofiller particle and the plurality of sacrificial material molecules may include one or more of a branched or an unbranched, saturated aldehyde (monoaldehyde) or a derivative thereof. For example, at least some (e.g., each) of a plurality of sacrificial material molecules bound to the biofiller particles may include one or more C₈-C₄₀ straight-chain saturated aldehydes or derivatives thereof. In some examples, the sacrificial material (e.g., C₈-C₄₀ straight-chain saturated aldehydes) may include any of the sacrificial materials disclosed herein, such as one or more of octanal, nonanal, decanal, undecanal, dodecanal, tridecanal, butadecanal, hexadecanal, octadecanal, etc. In some examples, at least some of a plurality of sacrificial material molecules conjugated to a biofiller particle may include one or more C₈-C₄₀ branched, saturated aldehydes having one or more methyl groups, ethyl groups, or combinations thereof disposed on a saturated straight-chain aldehyde backbone.

In some examples, the biofiller particles in the polymer composition 134 may include biofiller particles comprising ground plant fibers, such as any of the plant fibers or materials disclosed herein (e.g., one or more of ground pulp, husks, shells, hulls, fruit, or seeds of a plant). For example, the ground plant fibers may include ground or otherwise sized coconut hull particles (e.g., micron scale particles).

In some examples, the polymer matrix may include any of the polymers 132 disclosed herein, such as one or more hydrophobic polymers. For example, the polymer matrix of the polymer composition 134 may include one or more of an acrylic, polyethylene terephthalate, polystyrene, polymethyl methacrylate, polyethylene, polypropylene, polyvinylidene fluoride, polytetrafluoroethylene, polyamide, polyimide, derivatives of any of the foregoing, or copolymers including one or more of any of the foregoing.

In some examples, the polymer composition 134 (e.g., polymer material) may include a sacrificial material content of at least about 1 wt % of the polymer composition 134, such as in a range from about 1 wt % to about 50 wt %, about 5 wt % to about 40 wt %, about 10 wt % to about 40 wt %, about 20 wt % t to about 30 wt %, about 1 wt % to about 10 wt %, about 5 wt % to about 15 wt %, about 10 wt % to about 20 wt %, about 20 wt % to about 30 wt %, less than about 50 wt %, less than about 30 wt %, less than about 20 wt %, less than about 10 wt %, or less than about 5 wt % of the polymer composition 134. In some examples, the polymer composition 134 may include a biofiller particle content (e.g., with or without the sacrificial material bound thereto) of at least about 1 wt % of the polymer composition 134, such as in a range from about 5 wt % to about 50 wt %, about 10 wt % to about 40 wt %, about 15 wt % to about 35 wt %, about 20 wt % to about 30 wt %, about 10 wt % to about 20 wt %, about 20 wt % to about 40 wt %, about 30 wt % to about 50 wt %, less than about 40 wt %, less than about 20 wt %, less than about 10 wt %, or less than about 5 wt % of the polymer composition 134. In some examples, the polymer content of the polymer composition 134 may include the balance of any combination of the ranges for sacrificial material and biofiller particle contents disclosed herein. For example, the polymer 132 may make up about 1 wt % or more of the polymer composition 134, such as in a range from about 1 wt % to about 98 wt %, about 10 wt % to about 80 wt %, about 25 wt % to about 75 wt %, about 20 wt % to about 60 wt %, about 5 wt % to about 50 wt %, about 50 wt % to about 98 wt %, about 60 wt % to about 90 wt %, about 50 wt % to about 80 wt %, about 40 wt % to about 70 wt %, more than about 50 wt %, more than about 75 wt %, more than about 80 wt %, or less than about 90 wt % of the polymer composition 134.

In some examples, the method 100 may include forming a polymer composite body from the polymer composition 134. For example, the method 100 may include forming a polymer composite body at least a portion of which exhibits a thickness of at least about 50 μm, such as in a range from about 50 μm to about 10 cm, about 100 μm to about 5 cm, about 250 μm to about 3 cm, about 500 μm to about 1 cm, about 1 cm to about 10 cm, about 100 μm to about 1 cm, about 50 μm to about 1 cm, about 50 μm to about 5 mm, about 100 μm to about 3 mm, about 250 μm to about 2 mm, about 500 μm to about 5 mm, about 1 mm to about 1 cm, about 1 mm to about 5 mm, about 50 μm to about 1 mm, about 100 μm to about 500 μm, about 200 μm to about 700 μm, about 500 μm to about 1 mm, less than about 10 cm, less than about 5 cm, less than about 1 cm, less than about 5 mm. less than about 3 mm, less than about 1 mm, or less than about 500 μm. In some examples, the polymer composition 134 may be formed into a thin film or sheet having any of the above noted thicknesses.

In some examples, one or more of acts 110-130 may include maintaining the one or more of biofiller particles, the sacrificial material, or the polymer at a selected temperature. The selected temperature can reduce or eliminate browning and odor formation of the biofiller particles. For example, maintaining the temperature of the polymer, the biofiller particles, and the second enzyme 124 below about 140° C. for less than about 6 hours can reduce or eliminate biofiller browning and odors due to Maillard reactions between sugars and amino acids in the biofiller particles. Further reductions in one or more of temperature or duration can result in further limitation of browning, odor formation, and overall decomposition of the biofiller particles. Such limitation to decomposition may be due, at least in part, to limiting or avoiding Maillard reaction conditions by terminating said reaction with aldehyde containing saturated hydrocarbons (e.g., alkyl monoaldehydes). In some examples, stabilizing the biofiller particles and/or dispersing the stabilized biofiller particles in the polymer may include controlling the temperature of the polymer, the biofiller particles, and the sacrificial material to below about 110° C. for less than about 1 hour. Put another way, one or more of the stabilization of the biofiller particles and the dispersion of the stabilized biofiller particles is carried out in less than an hour, and the materials are only subjected to the 110° C. temperature for about an hour or less. At the end of the duration, the polymer composition 134 is cooled, either by removing a heat source associated with the reactions or dispersing or by outputting the polymer composition from a mixing apparatus (e.g., mixer or extruder).

In alternative examples, the sacrificial material 112 may include a fatty amine and the surface functional groups 146 may include carbonyl groups and/or other functional groups of polysaccharides, complex carbohydrates, or other components of biofiller particles. In such examples, the fatty amine may include a saturated alkyl backbone (e.g., having no or limited hydroxyl groups thereon). The fatty amine may include at least 8 carbon units, such as any number of carbon units disclosed herein with respect to a sacrificial material. For example, the fatty amine may include an amine such as a C₈-C₄₀ saturated amine (e.g., straight chain or branched), which may include any of the sacrificial materials disclosed herein (e.g., such as one or more of caprylic amine, capric amine, lauryl amine, myristyl amine, palmityl amine, or stearyl amine, etc.) Such fatty amities are relatively smaller and more mobile than polysaccharides, proteins, or complex carbohydrates present in biofiller particles and therefore are able to outcompete said materials for binding to the surface functional groups (e.g., carbonyl functional groups), thereby rendering the biofiller particles substantially hydrophobic and terminating/preventing Maillard reactions. For example, C₈-C₄₀ saturated (e.g., fatty) amines have a much smaller molecular structure than proteins and therefore may be more mobile than proteins when competing for binding sites at carbonyl containing surface functional groups.

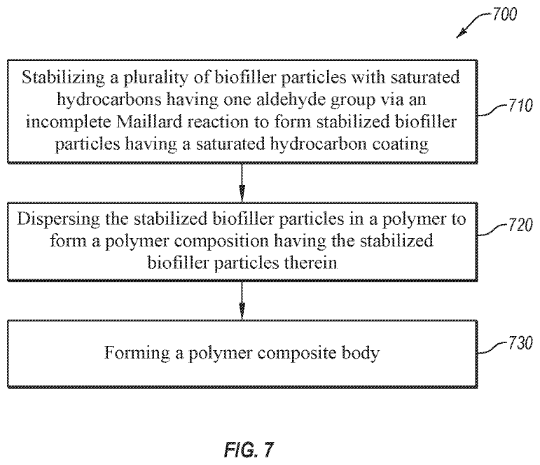

FIG. 7 is a flow chart of a method 700 of forming a polymer composition and polymer articles having stabilized biofiller particles therein, according to at least one example. An example method may include one or more operations, functions or actions as illustrated by one or more of blocks 710, 720, and/or 730. A polymer composite article may include an article having a composite including any of the polymer compositions disclosed herein. In some examples, the term polymer composition may differ from the term polymer composite only in name for differentiating between bodies having the polymer composition therein. That is, in some examples, the term “polymer composition” can be used interchangeably with the term “polymer composite,” when context allows.

The example method 700 may begin with block 710, which recites “stabilizing a plurality of biofiller particles with saturated hydrocarbons having one aldehyde group via an incomplete Maillard reaction to form stabilized biofiller particles having a saturated hydrocarbon coating.” Block 710 may be followed by block 720, which recites “dispersing the stabilized biofiller particles in a polymer to form a polymer composition having the stabilized biofiller particles therein.” Block 720 may be followed by block 730, which recites “manufacturing a polymer composite article using the polymer composition.”

The blocks included in the described example methods are for illustration purposes. In some embodiments, the blocks may be performed in a different order. In some other embodiments, various blocks may be eliminated. In still other embodiments, various blocks may be divided into additional blocks, supplemented with other blocks, or combined together into fewer blocks. Other variations of these specific blocks are contemplated, including changes in the order of the blocks, changes in the content of the blocks being split or combined into other blocks, etc. In some examples, block 710 and block 720 can be performed simultaneously.

Block 710 recites, “stabilizing a plurality of biofiller particles with saturated hydrocarbons having one aldehyde group via an incomplete Maillard reaction to form stabilized biofiller particles having a saturated hydrocarbon coating.” In some examples, stabilizing a plurality of biofiller particles with saturated hydrocarbons having one aldehyde group via an incomplete Maillard reaction to form stabilized biofiller particles having a saturated hydrocarbon coating can include any of the blocks 110-120, or any aspects thereof disclosed herein. For example, stabilizing a plurality of biofiller particles with saturated hydrocarbons having one aldehyde group via an incomplete Maillard reaction to form stabilized biofiller particles having a saturated hydrocarbon coating may include combining biofiller particles with a sacrificial material (e.g., saturated aldehyde), including any aspects thereof disclosed herein. For example, stabilizing the plurality of biofiller particles may include combining or applying one or more C₈-C₄₀ branched or unbranched, saturated aldehydes (e.g., free of hydroxyl functional groups) to the plurality of biofiller particles. In some examples, the stabilizing a plurality of biofiller particles with saturated hydrocarbons having one aldehyde group via an incomplete Maillard reaction to form stabilized biofiller particles having a saturated hydrocarbon coating may include providing any of the biofiller particles and/or sacrificial materials disclosed herein. In some examples, combining biofiller particles with a sacrificial material may include combining the sacrificial material with a plurality of biofiller particles (e.g., porous biofiller particles), wherein the sacrificial material includes a hydrocarbon having at least 8 carbons and a single carbonyl functional group (e.g., aldehyde group), wherein the biofiller particles include one or more of a protein or an amino acid having amino groups on a surface thereof. In some examples, stabilizing the biofiller particles with the saturated hydrocarbons may include dispersing the saturated hydrocarbons containing one aldehyde group and the plurality of biofiller particles in a solvent.

In some examples, stabilizing a plurality of biofiller particles with saturated hydrocarbons having one aldehyde group via an incomplete Maillard reaction to form stabilized biofiller particles having a saturated hydrocarbon coating may include reacting (e.g., non-thermally) the sacrificial material with the biofiller particles to form stabilized biofiller particles, including any aspects thereof disclosed herein (e.g., with respect to act 120). In some examples, reacting the sacrificial material with the biofiller particles to form stabilized biofiller particles include reacting the sacrificial material with the biofiller particles to form stabilized biofiller particles having a coating of sacrificial material thereon. For example, stabilizing a plurality of biofiller particles with saturated hydrocarbons having one aldehyde group via an incomplete Maillard reaction to form stabilized biofiller particles having a saturated hydrocarbon coating may include bonding the aldehyde group of the sacrificial material to one or more terminal amino groups on the biofiller particles. In some examples, stabilizing the plurality of biofiller particles may include non-thermally reacting the saturated hydrocarbons having one aldehyde group with the plurality of biofiller particles to form the stabilized biofiller particles having a coating of the saturated hydrocarbons having one aldehyde group or a derivative thereof. In some examples, stabilizing a plurality of biofiller particles with saturated hydrocarbons having one aldehyde group via, an incomplete Maillard reaction to form stabilized biofiller particles having a saturated hydrocarbon coating may include non-thermally reacting the sacrificial material with the biofiller particles to form coated biofiller particles having a coating of sacrificial material thereon, such as using PEF as disclosed herein. For example, stabilizing the biofiller particles with the saturated hydrocarbons may include conjugating carbonyl groups of the saturated hydrocarbons (e.g., aldehydes) with amino groups on the plurality of biofiller particles by applying a PEF to the saturated hydrocarbons and the plurality of biofiller particles. In some examples, applying the PEF may include applying the PEF to the saturated hydrocarbons having one aldehyde group and the plurality of biofiller particles for less than about 5 milliseconds and/or at an intensity in a range from about 10 kV/cm to about 60 kV/cm. Applying PEF to the saturated hydrocarbons having one aldehyde group and the plurality of biofiller particles may be effective to cause the aldehyde functional groups of the sacrificial material to conjugate with the terminal amino groups of the plurality of biofiller particles.

In some examples, non-thermally reacting the sacrificial material with the plurality of biofiller particles to form the stabilized biofiller particles having the coating of the saturated hydrocarbons having one aldehyde group or a derivative thereof may include conjugating the single aldehyde-functional group of the saturated hydrocarbons having one aldehyde-group or a derivative thereof with the amino groups of the plurality of biofiller particles effective to cause the stabilized biofiller particles to have a hydrophobic coating thereon.

Block 720 recites “dispersing the stabilized biofiller particles in a polymer to form a polymer composition having the stabilized biofiller particles therein.” In some examples, dispersing the stabilized biofiller particles in a polymer to form a polymer composition having the stabilized biofiller particles therein can be similar or identical to the act 130 disclosed herein, in one or more aspects. For example, dispersing the stabilized biofiller particles in (e.g. into) the polymer may include dispersing any of the stabilized biofiller particles disclosed herein into any of the polymers disclosed herein. For example, dispersing the stabilized biofiller particles in a polymer to form a polymer composition may include dispersing the stabilized biofiller particles 150 or 150′ into a polymer matrix including one or more of thermoplastic polymer layers may include acrylic, polyethylene terephthalate, polystyrene, polymethyl methacrylate, polycarbonate, polyethylene (e.g., high-density polyethylene (“HDPE”), low-density polyethylene (“LDPE”)), polyvinyl chloride (“PVC”), polyvinylidenechloride, polyvinylidene fluoride, polytetrafluoroethylene, polylactic acid (“PLA”), a polyhydroxy acid(s) (“PHA”), polyhydroxybutyrate (“PHB”), adipic acid, polyacrylic acid, ethylene vinyl alcohol, acrylonitrile butadiene styrene, polypropylene, polyamide, polyimide, polyurethane, polyetherimide, polyether ether ketone, polysulfone, polyoxymethylene, any other hydrophobic polymer suitable for use in packaging materials (e.g., food packaging, medical device packaging, etc.), derivatives of any of the foregoing (e.g., ions, salts, reaction products, etc.), or copolymers including one or more of any of the foregoing. Further polymers, beyond those listed above, may be used for the thermoplastic polymer. In some examples, the thermoplastic may be a homopolymer, copolymer, terpolymer, etc., having any of the polymers disclosed herein. In some examples, the polymer can be sourced from a renewable source or a non-renewable source.

As the stabilized biofiller particles are substantially hydrophobic, due to the sacrificial material coated thereon, the stabilized biofiller particles may readily disperse in a homogenous distribution into hydrophobic polymers. In some examples, dispersing the stabilized biofiller particles in a polymer to form a polymer composition having the stabilized biofiller particles therein may include mixing, stirring, shaking, ultrasonically vibrating, or otherwise agitating the polymer and the biofiller particles to aid in dispersion. In some examples, dispersing the stabilized biofiller particles in a polymer to form a polymer composition having the stabilized biofiller particles therein may include heating, drying, or otherwise setting the polymer matrix having the stabilized biofiller particles therein.

Block 730 includes forming a polymer composite body. In some examples, forming a polymer composite body may include forming one or more of a film, sheet, bag, block, plate, tube, box, panel, corrugated article, brick, or any other body from the polymer composition. For example, forming a polymer composite body may include extruding the polymer composition into a polymer composite body. In some examples, extruding the polymer composition into a polymer composite body can include extruding the polymer composition, such as in an extruder. In some examples, extruding the polymer composition into a polymer composite body can include extruding the polymer composition into one or more of a film, a tube, a rod, a block, or any other body. In some examples, forming the polymer composite body can include forming at least a portion of the polymer composition into a polymer composite body having one or more of a selected thickness, strength, resiliency, flexibility, transparency, or composition. For example, the polymer composite body (e.g., polymer composition layer) may exhibit a thickness of at least about 50 μm, such as in a range from about 50 μm to about 10 cm, about 100 μm to about 5 cm, about 250 μm to about 3 cm, about 500 μm to about 1 cm, about 1 cm to about 10 cm, about 100 μm to about 1 cm, about 50 μm to about 1 cm, about 50 μm to about 5 mm, about 100 μm to about 3 mm, about 250 μm to about 2 mm, about 500 μm to about 5 mm, about 1 mm to about 1 cm, about 1 mm to about 5 mm, about 50 μm to about 1 mm, about 100 μm to about 500 μm, about 200 μm to about 700 μm, about 500 μm to about 1 mm, less than about 10 cm, less than about 5 cm, less than about 1 cm, less than about 5 mm, less than about 3 mm, less than about 1 mm, or less than about 500 μm.

In some examples, forming the polymer composite body can include co-extruding the polymer composition with one or more additional layers adjacent thereto, such as one or more (thermoplastic) polymer layers. The resulting body (e.g., film, block, etc.) may include at least one layer of the polymer composition 150 (FIG. 1) and one or more layers of additional polymers. In some examples, the polymer of the one or more additional polymer layers may include any of the polymers disclosed herein. In some examples, the one or more additional layers can have a thickness equal to the thickness of the thermoplastic polymer layered disclosed above, or the layered system may exhibit a total thickness equal to the thicknesses disclosed above for the polymer composition.

In some examples, polymer composite body may include a first layer of polymer, a second layer of the polymer composition 134 (FIG. 1), and at least third layer of polymer. The second layer may be sandwiched between the first and third layers. Multilayered configurations may include one or more layers of polymer composition 134 and one or more layers of additional polymers (e.g., bio-derived thermoplastic or a synthetic thermoplastic). The one or more additional polymers can form one of an innermost or outermost layer(s) of a multilayered configuration. The thicknesses of each layer of the multilayer configuration can include any combination of the thicknesses for polymer compositions or films disclosed herein. The multilayered configuration can be formed via co-extrusion. For example, a polymer composition 134 core layer can be co-extruded between one or more additional polymer layers.

In some examples, block 730 forming a polymer composite body may include forming an article from the polymer composition, such as film, bag, packaging, building material, etc. In some examples, forming an article from the polymer composition includes using the polymer composite body comprising one or more of a film, a sheet, a block, a tube, or other body including any of the polymer compositions disclosed herein. In some examples, forming an article from the polymer composition includes one or more of pressing, cutting, perforating, laminating, molding, extruding, or folding the polymer composite body (e.g., polymer composition in a defined form) into an article. For example, forming an article from the polymer composite can include forming one or more of a film, a sheet, a tube, a block, packaging, a box, paneling, auto parts, or any other article.

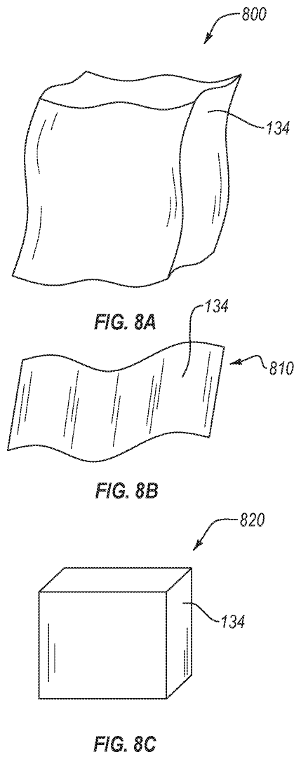

In some examples, manufacturing a polymer composite article using the polymer composite body can include forming one or more of the articles depicted in FIGS. 8A-8C. FIGS. 8A-8C are schematic illustrations of articles having any of the polymer compositions disclosed herein, according to various examples. FIG. 8A shows packaging 800 including one or more portions made from the polymer composition 134 (FIG. 1). The polymer composition may be formed (e.g., extruded or molded) into a packaging 800, such as a container or a bag as shown. In some examples, forming a polymer composite body of the block 730 of method 700 can include forming the packaging 800, such as via extrusion, co-extrusion, molding, welding, adhering, etc. The packaging 800 may be used to store food or other perishable items, store non-perishable goods (e.g., clothes, toys, etc.), used as garbage bags, used as grocery bags, or any other suitable purpose.

FIG. 8B shows film 810 including one or more portions made from the polymer composition 134. The polymer composition 134 may be similar or identical to any polymer composition disclosed herein. The polymer composition 134 may be formed into the film 810 via extrusion. In some examples, forming a polymer composite body of the block 730 of method 700 can include forming the film 810, such as via extrusion. The film 810 may be formed into a wrap, a bag, a portion of a box (e.g., window, top, or side). The film 810 may be formed into a roll for later use, may be used to cover food (e.g., cling wrap), or any other suitable purpose. The film can exhibit any number of layers or any number of thicknesses disclosed herein.

FIG. 8C shows a box 820 including one or more portions made from the polymer composition 134. The polymer composition 134 may be similar or identical to any polymer composition disclosed herein. In some examples, forming a polymer composite body of the block 730 of method 700 can include forming the box 820, such as via one or more of extrusion, stamping, perforating, corrugating, folding, etc. The box 820 may be formed into a box or preform (e.g., perforated sheet) for later use as a container, may be used to hold items, or any other suitable purpose. The box 820 may include one or more portions thereon containing the polymer composition 134, such as in a window, lid, or side. The remainder of the box may be any other material, such as cardboard, paperboard, a polymer, or wood; or may include one or more additional composite materials (e.g., polymer compositions having the same or a different composition than the polymer composition 134). The box 820 may have any configuration, such as a food container (e.g., containers traditionally made from polystyrene foam), on-shelf food boxes such as cereal, snack, or cookie boxes, etc.), beverage or fluid containers (e.g., cups, tubs, lids, or boxes), non-perishable goods boxes (e.g., clothes or toy boxes), corrugated material, or any other packaging.

In some examples, the polymer compositions disclosed herein may be used as a fibers, filler, or packaging material. In such examples, the polymer composition 134 may be formed into fibers. The polymer composition 134 may be cut into fibers from a film or may be directly formed into fibers such as via extrusion. The fibers may have any suitable size, such as at least about 1 mm wide (e.g., about 1 mm to about 2 cm or about 2 mm to about 1 cm) and about 1 mm long (e.g., about 1 mm to about 1 m, about 5 mm to about 10 cm, or about 2 mm to about 5 cm). The fibers may also be used for purposes other than packaging or fillers.

The thickness, material make-up, and extent of polymerization of the polymer composition 134 in any of the articles in FIGS. 8A-8C may be selected to provide a desired amount of strength, flexibility, resiliency, transparency, density, or other properties to the respective articles. The thickness of the polymer composition 134 may be any of the thicknesses for a polymer composition disclosed herein. In some examples, the polymer composition 134 may exhibit a selected biofiller particle content and/or a selected sacrificial material type and/or content to provide the desired physical properties to the respective articles. For example, the stabilized biofiller particle content of the box 820 (or a portion thereof containing the polymer composition 134) may be less than about 50 wt % (e.g., 30 wt %) of the polymer composition 134. In such examples, the stabilized biofiller particles may allow for use of less polymer in the polymer composition 134 (than those composite materials not containing biofiller particles), while retaining the desired physical characteristics of the polymer and using the stabilized biofiller particles in an environmentally friendly way. Further, stabilized biofiller particles may make use of waste such as by-products of food or pulp manufacturing. Additionally, stabilized biofiller particles may be less costly than polymers and thereby save production costs for packaging. In some examples, it may be desirable to include a fungicide or light blocker to the polymer composition 134 to prevent fungal growth in the box 820 or selected wavelengths of light from passing through the box 820. In some examples, the film 810 can include about 1 weight % to about 20 weight % stabilized biofiller particles, or about 2 weight % to about 10 weight % stabilized biofiller particles, and the plurality of stabilized biofiller particles may have an average particle size in a range from about 1 μm to about 5 μm.

The polymer composition of the polymer composite articles may include any polymer composition disclosed herein, including any species of components, any relative amounts of said components, and any other properties or characteristics disclosed herein. In some examples, the polymer compositions may exhibit a selected stabilized biofiller particles biofiller particle content, a selected sacrificial material content, and a polymer content to provide one or more desired properties. For example, polymer compositions may include a density suitable for use as a building material (e.g., window frames, decking material, etc.), automotive use (e.g., panels, trim, etc.), packaging (e.g., film, corrugated hoard, etc.), or any other use. In some examples, the density of the polymer compositions can be at least about 0.1 g/cc, such as in a range from about 0.1 g/cc to about 1.5 g/cc, about 0.5 g/cc to about 1.0 g/cc, about 0.7 g/cc to about 1.2 g/cc, about 0.9 g/cc to about 1.2 g/cc, about 1 g/cc to about 1.2 g/cc, less than about 1.5 g/cc, less than about 1.2 g/cc, or less than about 1.0 g/cc.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and, in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.), it will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

While the foregoing detailed description has set forth various examples of the devices and/or processes via the use of block diagrams, flowcharts, and/or examples, such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the examples disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. For example, if a user determines that speed and accuracy are paramount, the user may opt for a mainly hardware and/or firmware vehicle; if flexibility is paramount, the user may opt for a mainly software implementation; or, yet again alternatively, the user may opt for some combination of hardware, software, and/or firmware.

In addition, those skilled in the art will appreciate that the mechanisms of the subject matter described herein are capable of being distributed as a program product in a variety of forms, and that an illustrative example of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a Compact Disc (CD), a Digital Video Disk (DVD), a digital tape, a computer memory, etc.; and a transmission type medium such as a digital and/or an analog communication medium (e.g., a fiber optic cable, a waveguide, a wired communication link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

1. A method of stabilizing a biofiller, the method comprising:
combining a plurality of biofiller particles with a sacrificial material, wherein the sacrificial material includes a saturated hydrocarbon having at least 8 carbons and a single carbonyl functional group, wherein the plurality of biofiller particles include one or more of a protein or an amino acid having amino groups on a surface thereof; and
reacting the sacrificial material with the plurality of biofiller particles to form stabilized biofiller particles having a coating of sacrificial material thereon.

2. The method of claim 1, wherein combining the plurality of biofiller particles with the sacrificial material comprises applying a saturated aldehyde that is substantially free of hydroxyl groups to the biofiller particles.

3. (canceled)

4. (canceled)

5. The method of claim 1, wherein combining the plurality of biofiller particles with the sacrificial material comprises applying one or more C₈-C₄₀ straight-chain saturated aldehydes to the biofiller particles.

6. (canceled)

7. The method of claim 1, wherein combining the plurality of biofiller particles with the sacrificial material comprises applying a branched, saturated aldehyde having at least one of one or more methyl groups or one or more ethyl groups, disposed on a saturated straight-chain aldehyde backbone, to the biofiller particles.

8. (canceled)

9. (canceled)

10. The method of claim 1, wherein combining the plurality of biofiller particles with the sacrificial material comprises diffusing the sacrificial material into the biofiller particles dispersed in a solvent.

11. The method of claim 10, further comprising applying ultrasonic stimulation to the sacrificial materials and the plurality of biofiller particles dispersed in the solvent.

12. The method of claim 1, further comprising forming one or more pores in a surface of at least some of the plurality of biofiller particles; and
wherein combining the plurality of biofiller particles with the sacrificial material comprises diffusing the sacrificial material into the one or more pores formed in the surface of the plurality of biofiller particles.

13. The method of claim 12, wherein forming the one or more pores in the surface of the biofiller particles comprises applying a pulsed electric field to the biofiller particles.

14. (canceled)

15. The method of claim 1, wherein the plurality of biofiller particles comprise one or more of ground pulp, husks, shells, hulls, fruit, or seeds of a plant.

16. (canceled)

17. The method of claim 1, wherein reacting the sacrificial material with the biofiller particles comprises non-thermally reacting the sacrificial material with the biofiller particles.

18. The method of claim 1, wherein reacting the sacrificial material with the biofiller particles comprises applying a pulsed electric field to the sacrificial material and the plurality of biofiller particles effective to cause the carbonyl functional group of the sacrificial material to conjugate to the amino groups of the biofiller particles.

19. The method of claim 18, wherein applying the pulsed electric field to the sacrificial material and the plurality of biofiller particles effective to cause the carbonyl functional group of the sacrificial material to conjugate to the amino groups of the biofiller particles comprises applying the pulsed electric field for less than about 5 milliseconds.

20. The method of claim 18, wherein applying the pulsed electric field to the sacrificial material and the plurality of biofiller particles effective to cause the carbonyl functional group of the sacrificial material to conjugate to the amino groups of the plurality of biofiller particles comprises applying the pulsed electric field with an intensity in a range from about 10 kV/cm to about 60 kV/cm.

21. (canceled)

22. (canceled)

23. (canceled)

24. A method of forming a polymer composition including stabilized biofillers, the method comprising:
stabilizing a plurality of biofiller particles with saturated hydrocarbons having one aldehyde group via an incomplete Maillard reaction to form stabilized biofiller particles having a saturated hydrocarbon coating; and
dispersing the stabilized biofiller particles in a polymer to form a polymer composition having the stabilized biofiller particles therein.

25. The method of claim 24, wherein stabilizing the plurality of biofiller particles with the saturated hydrocarbons comprises applying a saturated straight-chain aldehyde that is substantially free of hydroxyl groups to the plurality of biofiller particles.

26. The method of claim 24, wherein stabilizing the plurality of biofiller particles with the saturated hydrocarbons comprises conjugating aldehyde groups of the saturated hydrocarbons with amino groups of the plurality of biofiller particles by applying a pulsed electric field to the saturated hydrocarbons and the plurality of biofiller particles.

27. (canceled)

28. (canceled)

29. (canceled)

30. (canceled)

31. (canceled)

32. (canceled)

33. (canceled)

34. (canceled)

35. (canceled)

36. (canceled)

37. The method of claim 24, wherein the biofiller particles include one or more of ground pulp, husks, shells, hulls, fruit, or seeds of a plant.

38. (canceled)

39. The method of claim 24, wherein dispersing the stabilized biofiller particles in the polymer comprises dispersing an amount of stabilized biofiller particles into the polymer composition to form a polymer composition having about 10 weight % to about 40 weight % of stabilized biofiller particles therein.

40. (canceled)

41. (canceled)

42. (canceled)

43. The method of claim 24 wherein dispersing the stabilized biofiller particles in the polymer comprises dispersing the stabilized biofiller particles into a polymer matrix including one or more hydrophobic polymers and the one or more hydrophobic polymers comprise an acrylic, polyethylene terephthalate, polystyrene, polymethyl methacrylate, polyethylene, polypropylene, polyvinylidene fluoride, polytetrafluoroethylene, polyamide, polyimide, or copolymers including one or more of any of the foregoing.

44. (canceled)

45. (canceled)

46. A polymer material, comprising:
a polymer matrix; and
a plurality of saturated hydrocarbon-coated biofiller particles substantially homogenously dispersed in the polymer matrix, wherein the plurality of saturated hydrocarbon-coated biofiller particles comprise a plurality of saturated hydrocarbon molecules conjugated to biofiller particles at amino groups or derivatives thereof on a surface of the biofiller particles.

47. (canceled)

48. The polymer material of claim 46, wherein the plurality of saturated hydrocarbon molecules are substantially free of hydroxyl groups.

49. (canceled)

50. (canceled)

51. (canceled)

52. (canceled)

53. The polymer material of claim 46, wherein the plurality of saturated hydrocarbon coated biofiller particles comprise ground plant fibers.

54. (canceled)

55. (canceled)

56. (canceled)

57. The polymer material of claim 46, wherein the polymer matrix comprises one or more hydrophobic polymers.

58. The polymer material of claim 46, wherein the polymer matrix comprises one or more of an acrylic, polyethylene terephthalate, polystyrene, polymethyl methacrylate, polyethylene, polypropylene, polyvinylidene fluoride, polytetrafluoroethylene, polyamide, polyimide, derivatives of any of the foregoing, or copolymers including one or more of any of the foregoing.

59. The polymer material of claim 46, wherein the plurality of saturated hydrocarbon coated biofiller particles are present in a range from about 10 weight % to about 40 weight % of the polymer material.

60. (canceled)

61. (canceled)

62. (canceled)
